(19) United States
(12) Patent Application Publication
(10) Pub. No.: US 2018/0105682 A1
(43) Pub. Date: Apr. 19, 2018

(54) TIRE MEMBER, AND METHOD FOR PRODUCING THE SAME

(71) Applicant: TOYO TIRE & RUBBER CO., LTD., Itami-shi (JP)

(72) Inventor: Souichiro Miura, Itami-shi (JP)

(73) Assignee: TOYO TIRE & RUBBER CO., LTD., Itami-shi (JP)

(21) Appl. No.: 15/655,106

(22) Filed: Jul. 20, 2017

(30) Foreign Application Priority Data
Oct. 14, 2016 (JP) 2016-202819

(51) Int. Cl. C08L 19/00; C08L 9/00; C08K 3/00; C08K 5/20; C08K 5/18; C08K 5/09; B60C 1/00

(52) U.S. Cl. CPC C08L 19/003; C08L 9/00; C08K 3/0033; B60C 1/00; C08K 5/18; C08K 5/09; C08K 5/20

(57) ABSTRACT

A tire member, comprising a diene based rubber, a filler, a rubber powder, and a compound represented by the following formula (I):

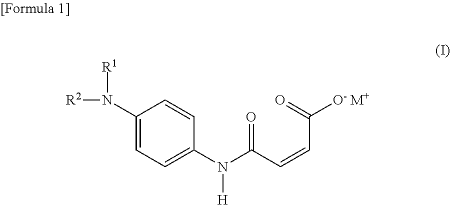

wherein R¹ and R² each represent a hydrogen atom, or an alkyl group, alkenyl group or alkynyl group which has 1 to 20 carbon atoms, and may be the same as or different from each other; and M⁺ represents a sodium ion, a potassium ion, or a lithium ion.

### BACKGROUND OF THE INVENTION

### Field of the Invention

The present invention relates to a tire member, and a method for producing the tire member.

### Description of the Related Art

Hitherto, rubber product scrap materials, such as a waste tire, have been reused. For example, the materials have been used as fuels in cement factories and others. In recent years, under the consideration of environmental problems, material recycling has been recommended in which waste tires or others are pulverized and the resultant is used as it is as rubber pieces or a rubber powder. However, when a rubber powder obtained by pulverizing, e.g., waste tires into fine particles is blended into a new rubber, there arise problems that the resultant rubber composition is raised in viscosity to be deteriorated in workability, and a vulcanized rubber obtained by vulcanizing the rubber composition is deteriorated in physical properties, for example, in tensile strength and other properties.

Patent Document 1 identified below reports a technique of adding a specified block polymer into a vulcanized rubber of a rubber composition into which a vulcanized rubber powder is blended, a purpose of the addition being to prevent the vulcanized rubber from being lowered in tearing strength.

Patent Document 2 identified below reports a technique of using a rubber composition into which a specified compound is blended, so as to improve physical properties of a tire.

### PRIOR ART DOCUMENTS

### Patent Documents

Patent Document 1: JP-A-08-134267

Patent Document 2: JP-A-2014-95014

However, Patent Document 2 neither discloses nor suggests the point that an improvement is made in physical properties of a vulcanized rubber into which a rubber powder obtained using waste tires as a raw material is blended, for example, in the tensile strength of the vulcanized rubber.

### SUMMARY OF THE INVENTION

In light of the above-mentioned actual situation, an object of the present invention is to provide a tire member which includes a rubber powder and which can be a raw material of a vulcanized rubber restrained from being lowered in tensile strength and tearing strength; and a method for producing the tire member.

The object can be attained by the present invention, which is the following:

A tire member, including a diene based rubber, a filler, a rubber powder, and a compound represented by the following formula (I):

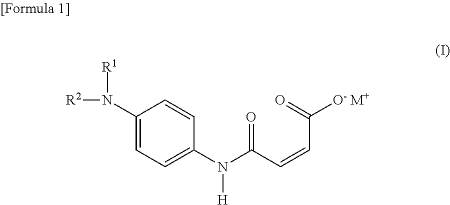

wherein R¹ and R² each represent a hydrogen atom, or an alkyl group, alkenyl group or alkynyl group which has 1 to 20 carbon atoms, and may be the same as or different from each other; and M⁺ represents a sodium ion, a potassium ion, or a lithium ion.

In the tire member according to the present invention, the diene based rubber component and the filler come to be easily bonded to the rubber powder and the filler by aid of the compound represented by the formula (I), so that the filler is excellent in dispersibility, and further the diene based rubber component and the rubber powder come to be easily bonded to each other by aid of the filler. In other words, four components that are the diene based rubber, the filler, the rubber powder, and the compound represented by the formula (I) are improved in dispersibility into each other, and further interaction between the diene based rubber and the rubber powder becomes strong. As a result, the tire member according to the present invention is restrained from being lowered in tensile strength and tearing strength after vulcanized.

The present invention also relates to a process for producing a tire member, including the step of mixing the following components with each other: a diene based rubber, a filler, a rubber powder, and a compound represented by the following formula (I):

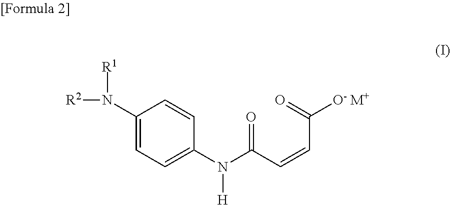

wherein R¹ and R² each represent a hydrogen atom, or an alkyl group, alkenyl group or alkynyl group which has 1 to 20 carbon atoms, and may be the same as or different from each other; and M⁺ represents a sodium ion, a potassium ion, or a lithium ion.

This process, for producing a tire member, preferably includes the step of mixing the components with each other in advance, the components being the diene based rubber, the filler, the rubber powder, and the compound represented by the following formula (I):

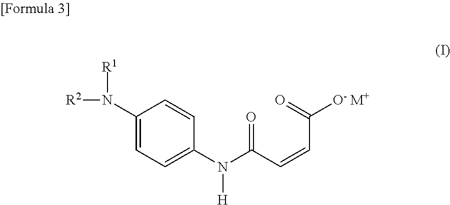

wherein R¹ and R² each represent a hydrogen atom, or an alkyl group, alkenyl group or alkynyl group which has 1 to 20 carbon atoms, and may be the same as or different from each other; and M⁺ represents a sodium ion, a potassium ion, or a lithium ion. It is particularly preferred that this process includes the step of mixing the components except any antiaging agent, any wax, stearic acid, sulfur, and others with each other in advance, the components being the diene based rubber, the filler, the rubber powder, and the compound represented by the formula (I).

As described above, the tire member according to the present invention exhibits the advantageous effects by interaction between the four components of the diene based rubber, the filler, the rubber powder, and the compound represented by the formula (I) on the basis of, for example, the matter that the four components are bonded to each other. It is therefore preferred to mix the four components of the diene based rubber, the filler, the rubber powder, the compound represented by the formula (I) with each other in advance (mixing in advance) to heighten the interaction between the four components, and subsequently, if necessary, blending other blending agents such as an antiaging agent, a wax, stearic acid, and sulfur into the resultant mixture to produce the tire member.

### DETAILED DESCRIPTION OF THE PREFERRED EMBODIMENTS

The tire member according to the present invention includes a diene based rubber, a filler, a rubber powder, and a compound represented by the formula (I).

Examples of the diene based rubber include natural rubber (NR); diene based synthetic rubbers such as isoprene rubber (IR), butadiene rubber (BR), styrene-butadiene rubber (SBR), butyl rubber (IIR), and acrylonitrile-butadiene rubber (NBR); halogenated butyl rubbers such as brominated butyl rubber (BR-IIR), and other synthetic rubbers such as polyurethane rubber, acrylic rubber, fluorine-contained rubber, silicone rubber, and chlorosulfonated polyethylene. It is preferred in the present invention to use, out of these examples, natural rubber.

In the present invention, the filler denotes an inorganic filler used ordinarily in the rubbery industry, such as carbon black, silica, clay, talc, calcium carbonate, magnesium carbonate, and aluminum hydroxide. Out of these inorganic fillers, carbon black is in particular preferably usable in the invention. Alternatively, carbon black and silica may be used in combination.

The species of carbon black may be any carbon black species used in an ordinary rubbery industry, such as SAF, ISAF, HAF, FEF or GPF, or may be an electroconductive carbon black species such as acetylene black or ketjen black. The form of carbon black may be granulated carbon black, which has been granulated, considering the handleability thereof in an ordinary rubbery industry; or may be non-granulated carbon black.

In the present invention, the blend amount of the filler in the tire member is preferably from 20 to 100 parts by mass, more preferably from 30 to 80 parts by mass for 100 parts by mass of the diene based rubber.

The rubber powder is preferably a rubber powder that has been at least partially vulcanized, and is in particular preferably a rubber powder obtained by making a reused rubber obtained using, as a raw material, used tires into a powdery form. Considering the tensile strength and the tearing strength of the resultant vulcanized rubber, and the workability of the tire member, under the use of the unit of “mesh” according to ASTM D5644-01, the particle diameter of the rubber powder ranges preferably from 80 to 270 mesh, more preferably from 140 to 230 mesh.

In the present invention, the tire member further includes a compound represented by the following formula (I):

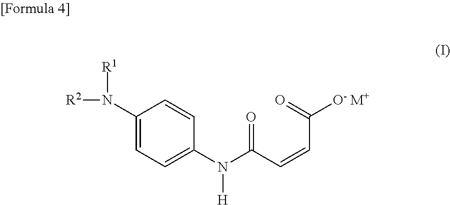

wherein R¹ and R² each represent a hydrogen atom, or an alkyl group, alkenyl group or alkynyl group which has 1 to 20 carbon atoms, and may be the same as or different from each other; and M⁺ represents a sodium ion, a potassium ion, or a lithium ion.

In order to heighten the compound in affinity with the filler, particularly, carbon black, it is especially preferred to use a compound in which R¹ and R² in the formula (I) are each a hydrogen atom and M⁺ therein is a sodium ion, this compound being represented by the following formula (I′):

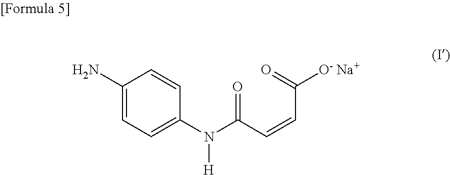

When properties of the vulcanized rubber are considered, the blend amount of the compound represented by the (I) is preferably from 0.1 to 10 parts by mass, more preferably from 0.2 to 8 parts by mass for 100 parts by mass of the diene based rubber.

Together with the diene based rubber, the filler, the rubber powder and the compound represented by the formula (I), any blending agent that is ordinarily used in the rubbery industry may be appropriately blended into the tire member of the present invention as far as the blending agent does not damage the advantageous effects of the present invention. Examples of the blending agent include a sulfur-containing vulcanizer, a vulcanization promoter, a silane coupling agent, stearic acid, a vulcanization promoting aid, a vulcanization retardant, an antiaging agent, softeners such as wax and oil, and a working aid.

The vulcanization promoter may be a vuicanization promoter used ordinarily for rubber vulcanization. Examples thereof include sulfenamide type, thiuram type, thiazole type, thiourea type, guanidine type, and dithiocarbamate type vulcanization promoters. These vulcanization promoters may be used singly or in the form of an appropriate mixture.

The antiaging agent may be an antiaging agent used ordinarily for rubbers. Examples thereof include aromatic amine type, amine-ketone type, monophenolic type, bisphenolic type, polyphenolic type, dithiocarbamate type, and thiourea type antiaging agents. These antiaging agents may be used singly or in the form of an appropriate mixture.

The tire member of the present invention can be obtained by mixing and kneading the above-defined diene based rubber, filler, rubber powder, and compound represented by the formula (I), and components that may be optionally used, using a kneading machine used in an ordinal rubbery industry, such as a Banbury mixer, a kneader or a roll, examples of the optionally used components including a sulfur-containing vulcanizer, a vulcanization promoter, a silane coupling agent, stearic acid, a vulcanization promoting aid, a vulcanization retardant, an antiaging agent, softeners such as wax and oil, and a working aid.

The method for blending these individual components with each other is not particularly limited, and rosy be any one of a method of kneading, in advance, blending components other than the sulfur-containing vulcanizer, the vulcanization promoter and any other vulcanization-related component to prepare a masterbatch, adding the rest of the individual components to the masterbatch, and further kneading the mixture; a method of adding the individual components in any order to a kneading machine, and then kneading the mixture; a method of adding the whole of the individual components simultaneously to a kneading machine, and then kneading the mixture; and other methods.

However, in order to restrain the resultant vulcanized rubber sufficiently from being lowered in tensile strength and tearing strength, it is preferred to mix the diene based rubber, the filler, the rubber powder, and the compound represented by the formula (I) with each other in advance, blending and dispersing the four components sufficiently into each other, and then mixing the other blending agents with the resultant blend in the sufficiently blended and dispersed state to produce a tire member.

### EXAMPLES

Hereinafter, this invention will be more specifically described by demonstrating working examples of the invention.

Preparation of Rubber Compositions

In accordance with a blending formulation shown in Table 1, raw materials in each of Examples 1 to 6 and Comparative Examples 1 and 2 were blended into 100 parts by mass a diene based rubber. An ordinary Banbury mixer was used to knead the raw materials to produce a tire member. In each of Examples 3 to 6, four components of the diene based rubber, the filler, the rubber powder, and the compound represented by the formula (I) were blended with each other in advance, and subsequently the other components were mixed with the resultant blend. The individual used raw materials described in Table 1 are as follows:

### Used Materials

Natural rubber (NR): “RSS #3”,

Silica: “NIPSIL AQ” (manufactured by Tosoh Silica Corp.; BET specific surface area: 205 m²/g, CTAB: 175 m²/g, and DBP absorbed amount: 150 cm³/100 g),

Carbon black: “SEAST KH”, manufactured by Tokai Carbon Co., Ltd.,

Zinc flower: ZINC FLOWER No. 1, manufactured by Mitsui mining & Smelting Co., Ltd.,

Antiaging agent: “NOCRAC 6C”, manufactured by Ouchi Shinko Chemical Industrial Co., Ltd.,

Stearic acid: “RUNAC S20”, manufactured by Kao Corp.,

Wax: “OZOACE 0355”, manufactured by Nippon Seiro Co., Ltd.,

Silane coupling agent: “S175”, manufactured by Degussa AG,

Compound represented by the formula (I): sodium (2Z)-4-[(4-aminophenyl)amino]-4-oxo-2-butenoate,

Rubber powder (A): “PolyDyne 140”, manufactured by Lehigh Technologies, Inc.,

Rubber powder (B): “PolyDyne 200”, manufactured by Lehigh Technologies, Inc.,

Sulfur: “Powdery Sulfur”, manufactured by Tsurumi Chemical Industry Co., Ltd., and

Vulcanization promoter: “SOXINOL CZ”, manufactured by Sumitomo Chemical Co., Ltd.

### Evaluation Items

(1)Tensile Properties (Tensile Strength and Tensile Elongation)

In accordance with JIS K 6251, a tensile test (dumbbell No. 3 specimen; atmosphere temperature: 23° C.) was made about the tire members of the examples. The results are each shown as an index relative to each of the results of Comparative Example 1, the result being regarded as 100. As index values of any one of the examples are larger, the example is better in tensile strength and tensile elongation.

(2) Tearing Strength

In accordance with JIS K 6252, the tearing strength of each of the examples was measured. The results are each shown as an index relative to the results of Comparative Example 1, the result being regarded as 100. As an index value of any one of the examples is larger, the example is better in tearing strength.

TABLE 1

| | Comparative | Comparative | Comparative | Comparative | Comparative | | |
|---|---|---|---|---|---|---|---|
| Blending agents | Example 1 | Example 2 | Example 3 | Example 4 | Example 5 | Example 1 | Example 2 |
| NR | 100 | 100 | 100 | 100 | 100 | 100 | 100 |
| Silica | 0 | 10 | 10 | 10 | 0 | 0 | 0 |
| Carbon black | 60 | 30 | 60 | 80 | 60 | 60 | 60 |
| Zinc flower | 3 | 3 | 3 | 3 | 3 | 3 | 3 |
| Antiaging agent | 2 | 2 | 2 | 2 | 2 | 2 | 2 |
| Stearic acid | 2 | 2 | 2 | 2 | 2 | 2 | 2 |
| Wax | 2 | 2 | 2 | 2 | 2 | 2 | 2 |
| Silane coupling agent | 0 | 0 | 0 | 0 | 0 | 0 | 0 |
| Compound represented by | 0 | 0 | 0 | 0 | 0 | 0.2 | 0.2 |
| formula (I) | | | | | | | |
| Rubber powder (A) | 0 | 0 | 0 | 0 | 20 | 20 | 0 |
| Rubber powder (B) | 0 | 0 | 0 | 0 | 0 | 0 | 20 |
| Sulfur | 2 | 2 | 2 | 2 | 2 | 2 | 2 |
| Vulcanization promoter | 2 | 2 | 2 | 2 | 2 | 2 | 2 |
| Mixing of NR, carbon black | Not done | Not done | Not done | Not done | Not done | Not | Not |
| (silica), rubber powder, | | | | | | done | done |
| and compound represented | | | | | | | |
| by formula (I) in advance | | | | | | | |
| Tensile strength | 100 | 80 | 95 | 110 | 91 | 100 | 101 |
| Tensile elongation | 100 | 108 | 105 | 90 | 94 | 101 | 102 |
| Tearing strength | 100 | 82 | 95 | 108 | 95 | 108 | 109 |

| | | | | | | | | Example |
|---|---|---|---|---|---|---|---|---|
| Blending agents | Example 3 | Example 4 | Example 5 | Example 6 | Example 7 | Example 8 | Example 9 | 10 |
| NR | 100 | 100 | 100 | 100 | 100 | 100 | 100 | 100 |
| Silica | 0 | 0 | 0 | 0 | 10 | 10 | 10 | 10 |
| Carbon black | 60 | 60 | 60 | 60 | 30 | 30 | 80 | 80 |
| Zinc flower | 3 | 3 | 3 | 3 | 3 | 3 | 3 | 3 |
| Antiaging agent | 2 | 2 | 2 | 2 | 2 | 2 | 2 | 2 |
| Stearic acid | 2 | 2 | 2 | 2 | 2 | 2 | 2 | 2 |
| Wax | 2 | 2 | 2 | 2 | 2 | 2 | 2 | 2 |
| Silane coupling agent | 0 | 0 | 0 | 0 | 1 | 1 | 1 | 1 |
| Compound represented by | 1 | 1 | 2 | 2 | 0.5 | 0.5 | 5 | 5 |
| formula (I) | | | | | | | | |
| Rubber powder (A) | 20 | 0 | 20 | 0 | 20 | 0 | 20 | 0 |
| Rubber powder (B) | 0 | 20 | 0 | 20 | 0 | 20 | 0 | 20 |
| Sulfur | 2 | 2 | 2 | 2 | 2 | 2 | 2 | 2 |
| Vulcanization promoter | 2 | 2 | 2 | 2 | 2 | 2 | 2 | 2 |
| Mixing of NR, carbon black | Not | Not | Not | Not | Not | Not | Not | Not |
| (silica), rubber powder, | done | done | done | done | done | done | done | done |
| and compound represented | | | | | | | | |
| by formula (I) in advance | | | | | | | | |
| Tensile strength | 100 | 101 | 100 | 101 | 90 | 88 | 113 | 112 |
| Tensile elongation | 101 | 102 | 101 | 102 | 111 | 110 | 96 | 98 |
| Tearing strength | 106 | 105 | 108 | 109 | 96 | 96 | 116 | 114 |

TABLE 2

| | Example | Example | Example | Example | Example | Example |
|---|---|---|---|---|---|---|
| Blending agents | 11 | 12 | 13 | 14 | 15 | 16 |
| NR | 100 | 100 | 100 | 100 | 100 | 100 |
| Silica | 0 | 0 | 10 | 10 | 0 | 0 |
| Carbon black | 60 | 60 | 50 | 50 | 60 | 60 |
| Zinc flower | 3 | 3 | 3 | 3 | 3 | 3 |
| Antiaging agent | 2 | 2 | 2 | 2 | 2 | 2 |
| Stearic acid | 2 | 2 | 2 | 2 | 2 | 2 |
| Wax | 2 | 2 | 2 | 2 | 2 | 2 |
| Silane coupling agent | 0 | 0 | 1 | 1 | 0 | 0 |
| Compound represented by formula (I) | 1 | 1 | 1 | 1 | 0.2 | 2 |
| Rubber powder (A) | 20 | 0 | 20 | 0 | 20 | 20 |
| Rubber powder (B) | 0 | 20 | 0 | 20 | 0 | 0 |
| Sulfur | 2 | 2 | 2 | 2 | 2 | 2 |
| Vulcanization promoter | 2 | 2 | 2 | 2 | 2 | 2 |
| Mixing of NR, carbon black (silica), | Done | Done | Done | Done | Done | Done |
| rubber powder, and compound | | | | | | |
| represented by formula (I) in advance | | | | | | |
| Tensile strength | 102 | 101 | 101 | 100 | 101 | 103 |
| Tensile elongation | 104 | 105 | 105 | 103 | 105 | 102 |
| Tearing strength | 110 | 112 | 109 | 108 | 108 | 111 |
| | Example | Example | Example | Example | Example | Example |
| Blending agents | 17 | 18 | 19 | 20 | 21 | 22 |
| NR | 100 | 100 | 100 | 100 | 100 | 100 |
| Silica | 10 | 10 | 10 | 10 | 10 | 10 |
| Carbon black | 50 | 50 | 30 | 80 | 30 | 80 |
| Zinc flower | 3 | 3 | 3 | 3 | 3 | 3 |
| Antiaging agent | 2 | 2 | 2 | 2 | 2 | 2 |
| Stearic acid | 2 | 2 | 2 | 2 | 2 | 2 |
| Wax | 2 | 2 | 2 | 2 | 2 | 2 |
| Silane coupling agent | 1 | 1 | 0 | 0 | 1 | 1 |
| Compound represented by formula (I) | 0.2 | 2 | 0.5 | 5 | 0.5 | 5 |
| Rubber powder (A) | 0 | 0 | 20 | 20 | 0 | 0 |
| Rubber powder (B) | 20 | 20 | 0 | 0 | 20 | 20 |
| Sulfur | 2 | 2 | 2 | 2 | 2 | 2 |
| Vulcanization promoter | 2 | 2 | 2 | 2 | 2 | 2 |
| Mixing of NR, carbon black (silica), | Done | Done | Done | Done | Done | Done |
| rubber powder, and compound | | | | | | |
| represented by formula (I) in advance | | | | | | |
| Tensile strength | 100 | 101 | 91 | 115 | 89 | 114 |
| Tensile elongation | 105 | 103 | 112 | 97 | 112 | 99 |
| Tearing strength | 108 | 110 | 97 | 119 | 97 | 116 |

What is claimed is:

1. A tire member, comprising a diene based rubber, a filler, a rubber powder, and a compound represented by the following formula (I): 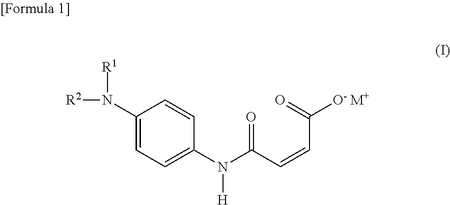
wherein R¹ and R² each represent a hydrogen atom, or an alkyl group, alkenyl group or alkynyl group which has 1 to 20 carbon atoms, and may be the same as or different from each other; and M⁺ represents a sodium ion, a potassium ion, or a lithium ion.

2. A process for producing a tire member, comprising the step of mixing the following components with each other: a diene based rubber, a filler, a rubber powder, and a compound represented by the following formula (I): 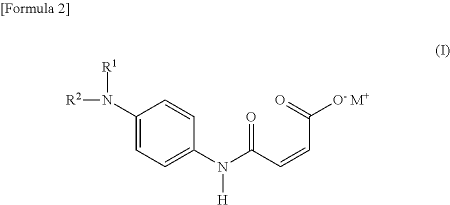
wherein R¹ and R² each represent a hydrogen atom, or an alkyl group, alkenyl group or alkynyl group which has 1 to 20 carbon atoms, and may be the same as or different from each other; and M⁺ represents a sodium ion, a potassium ion, or a lithium ion.

3. A process for producing a tire member, comprising the step of mixing the following components except any antiaging agent, any wax, stearic acid, sulfur, and others with each other in advance: a diene based rubber, a filler, a rubber powder, and a compound represented by the following formula (I): 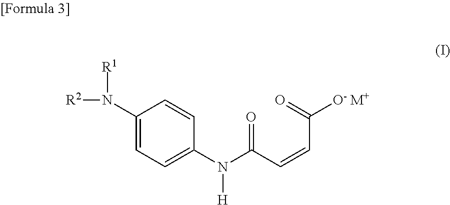
wherein R¹ and R² each represent a hydrogen atom, or an alkyl group, alkenyl group or alkynyl group which has 1 to 20 carbon atoms, and may be the same as or different from each other; and M⁺ represents a sodium ion, a potassium ion, or a lithium ion.
